(19) United States
(12) Patent Application Publication
(10) Pub. No.: US 2017/0044746 A1
(43) Pub. Date: Feb. 16, 2017

(54) Connecting Structure for Outlet Pipe of Faucet

(71) Applicant: Ching Shenger Co., Ltd., Xianxi Township (TW)

(72) Inventors: Chin-Tsai Lee, Xianxi Township (TW); Ming-Che Lee, Xianxi Township (TW)

(21) Appl. No.: 14/825,458

(22) Filed: Aug. 13, 2015

(51) Int. Cl. E03C 1/04; F16L 15/04

(52) U.S. Cl. CPC E03C 1/0404; F16L 15/04

(57) ABSTRACT

A connecting structure for an outlet pipe of a faucet contains: a body and an outlet pipe. The body is a thinly hollow cylinder and includes a circular orifice stamped on an inner wall thereof, a fitting tube horizontally extending outward to the body from a peripheral side of the circular orifice, and inner threads formed in the circular orifice and the fitting tube as one piece. The outlet pipe includes a connecting segment, an outlet segment, and a rotary connector fitted and limited in the connecting segment. The rotary connector has an outer threaded tube partially extending out of the connecting segment of the outlet pipe to screw with the inner threads formed in the circular orifice and the fitting tube, thus securely connecting the outlet pipe and the body together.

### BACKGROUND OF THE INVENTION

Field of the Invention

The present invention relates to a connecting structure, and more particularly to a connecting structure for an outlet pipe of a faucet.

Description of the Prior Art

A conventional faucet contains a body, and the body includes an outlet pipe connected therewith and a control valve accommodated therein, and an upper end of the control valve has a rotary lever fixed thereon, such that the rotary lever is rotated to drive the control valve, and the control valve turns on/off the faucet and controls water flow.

The body of the conventional faucet is casted from metal material, such as copper or stainless steel, but the body has many curved channels defined therein, so it is casted poorly and is manufactured complicatedly at a high cost. In addition, the faucet becomes a defective product, has a heavy weight, and cause environmental issues. To overcome such a problem, an outlet pipe is separated from a body of an assemblable faucet.

This assemblable faucet contains the body and the outlet pipe which are welded together along a connection seam, and then the body and the outlet pipe are polished, thus producing high processing cost. Furthermore, the body and the outlet pipe are polished roughly to cause air pores or false welding, so water leaks out of the air pores, and the body and the outlet pipe cannot be securely welded together because of the false welding. In a welding process, waste gas and high temperature will damage worker's health.

A connecting structure for an outlet pipe of a faucet is developed to solve above-mentioned defects and contains a hollow body in a cylinder shape, and the body includes at least one screwing orifice defined on a peripheral wall thereof to match with a connecting tube, a fitting tube, a connecting tube by which the outlet pipe is defined. The fitting tube has an outer screwing section to screw with the at least one screwing orifice of the body, and a stop ring is applied to stop water, such that the outlet pipe is in connection with the body.

However, the at least one screwing orifice is defined on the peripheral wall of the body, so the peripheral wall of the body has to be thick to arrange sufficient threads in the at least one screwing orifice so as to screw with outer threads of the fitting tube tightly. Nevertheless, the body is made of metal material to have high production cost, heavy weight, and inconvenient transportation.

The present invention has arisen to mitigate and/or obviate the afore-described disadvantages.

### SUMMARY OF THE INVENTION

The primary objective of the present invention is to provide a connecting structure for an outlet pipe of a faucet in which a circular orifice is stamped on an inner wall of the body, a fitting tube extends outward into the body from a peripheral side of the circular orifice, inner threads are formed in the circular orifice and the fitting tube, wherein the body is thin to form the inner threads for screwing with an outer threaded tube of a rotary connector of the outlet pipe securely, thus reducing manufacture material and cost of the body. Preferably, the faucet is lightweight and is conveyed easily.

Accordingly, a connecting structure for an outlet pipe of a faucet provided by the present invention contains: a body and an outlet pipe.

The body is a thinly hollow cylinder and includes a circular orifice stamped on an inner wall thereof, a fitting tube horizontally extending outward to the body from a peripheral side of the circular orifice, and inner threads formed in the circular orifice and the fitting tube as one piece.

The outlet pipe includes a connecting segment, an outlet segment, and a rotary connector fitted and limited in the connecting segment. The rotary connector has an outer threaded tube partially extending out of the connecting segment of the outlet pipe to screw with the inner threads formed in the circular orifice and the fitting tube, thus securely connecting the outlet pipe and the body together.

### BRIEF DESCRIPTION OF THE DRAWINGS

FIG. 1 is a perspective view showing the assembly of a connecting structure for an outlet pipe of a faucet according to a first embodiment of the present invention.

FIG. 2 is a perspective view showing the exploded components of the connecting structure for the outlet pipe of the faucet according to the first embodiment of the present invention.

FIG. 3 is a cross sectional view showing the exploded components of the connecting structure for the outlet pipe of the faucet according to the first embodiment of the present invention.

FIG. 4 is a cross sectional view showing the assembly of the connecting structure for the outlet pipe of the faucet according to the first embodiment of the present invention.

FIG. 5 is a cross sectional view showing the assembly of a connecting structure for an outlet pipe of a faucet according to a second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

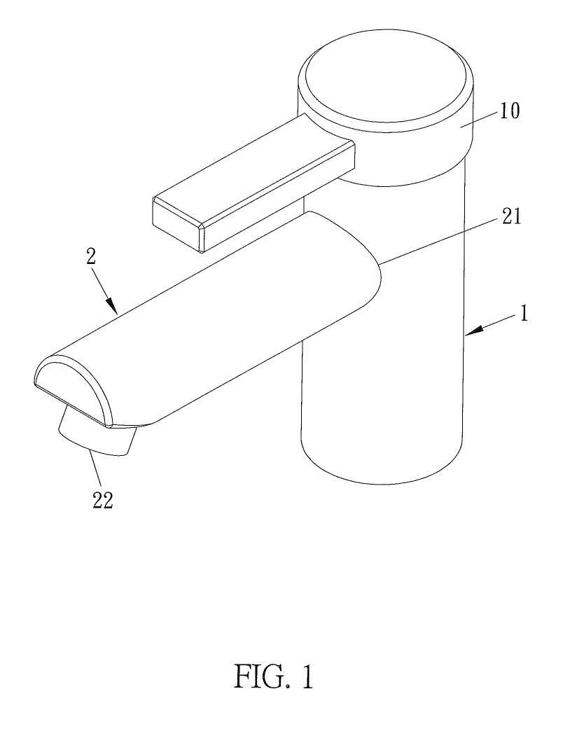

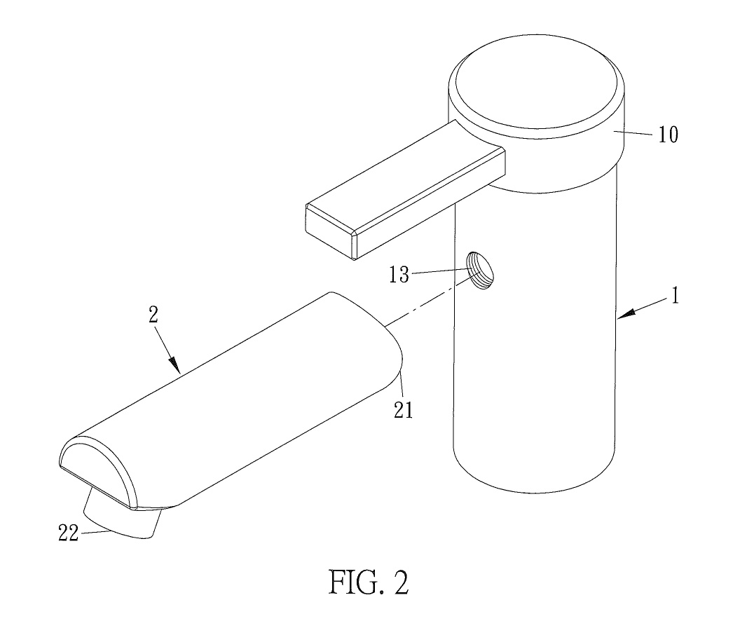

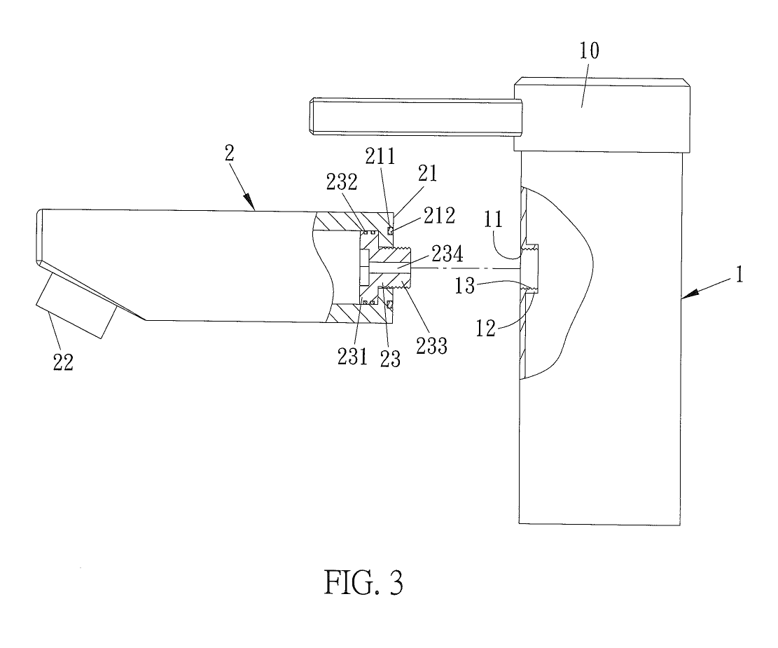

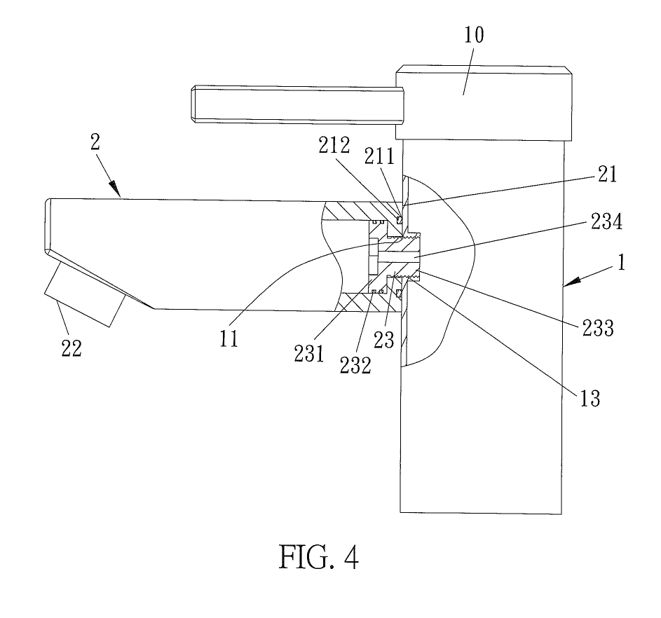

With reference to FIGS. 1 to 4, a connecting structure for an outlet pipe of a faucet according to a first embodiment of the present invention comprises: a body 1 and an outlet pipe 2, wherein the body 1 is made of metal and is a thinly hollow cylinder, and the body 1 includes a control valve (not shown) accommodated therein. The body 1 also includes a rotary lever 10 disposed on an upper end thereof, a circular orifice 11 stamped on an inner wall thereof, a fitting tube 12 horizontally extending outward into the body 1 from a peripheral side of the circular orifice 11, and inner threads 13 formed in the circular orifice 11 and the fitting tube 12 as one piece. The outlet pipe 2 includes a connecting segment 21, an outlet segment 22, and a rotary connector 23 fitted and limited in the connecting segment 21. The rotary connector 23 has a head portion 231 arranged on a first end thereof and retained in the connecting segment 21 of the outlet pipe 2, a stop ring 232 fitted on a peripheral side of the head portion 231 and contacting with an inner wall of the outlet pipe 2, an outer threaded tube 233 arranged on a second end thereof and partially extending out of the connecting segment 21 of the outlet pipe 2, and a through orifice 234 axially passing therethrough. The outlet pipe 2 further includes a groove 211 defined on an end surface of the connecting segment 21 and fitted with a closing ring 212, and the outer threaded tube 233 of the rotary connector 23 screws with the inner threads 13 formed in the circular orifice 11 and the fitting tube 12 of the body 1, such that the closing ring 212 of the connecting segment 21 of the outlet pipe 2 contacts with an outer wall of the body 1 to stop water leakage, thus the outlet pipe 2 horizontally coupling with the body 1 easily and stably.

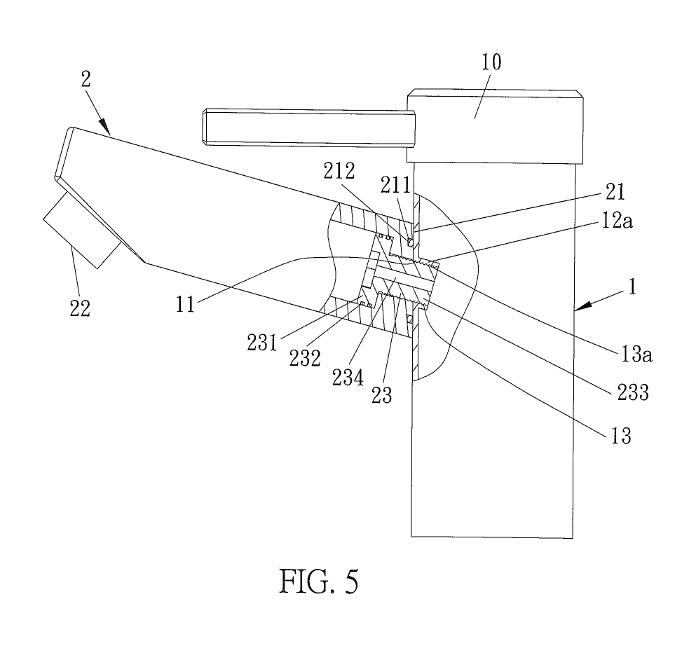

Referring to FIG. 5, a connecting structure for an outlet pipe of a faucet according to a second embodiment of the present invention comprises the circular orifice 11 stamped on an inner wall of the body 1, a fitting tube 12a obliquely extending outward into the body 1 from a peripheral side of the circular orifice 11, and inner threads 13a obliquely formed in the circular orifice 11 and the fitting tube 12a as one piece to cooperate with the connecting segment 21 of the outlet pipe 2, such that the outer threaded tube 233 of the rotary connector 23 screws with the inner threads 13a formed in the circular orifice 11 and the fitting tube 12a of the body 1, and the closing ring 212 of the connecting segment 21 of the outlet pipe 2 contacts with an outer wall of the body 1 to stop water leakage, hence the outlet pipe 2 obliquely couples with the body 1 easily and stably.

Thereby, the connecting structure for the outlet pipe contains advantage as follows:

The circular orifice 11 is stamped on the inner wall of the body 1, the fitting tube 12 extends outward into the body 1 from the peripheral side of the circular orifice 11, the inner threads 13 are formed in the circular orifice 11 and the fitting tube 12 as one piece, wherein the body 1 is thin to form the inner threads 13, 13a for screwing with the outer threaded tube 233 of the rotary connector 23 of the outlet pipe 2 securely, thus reducing manufacture material and cost of the body 1. Preferably, the faucet is lightweight and is conveyed easily.

While we have shown and described various embodiments in accordance with the present invention, it is clear to those skilled in the art that further embodiments may be made without departing from the scope of the present invention.

What is claimed is:

1. A connecting structure for an outlet pipe of a faucet comprising:
a body being a thinly hollow cylinder and including a circular orifice stamped on an inner wall thereof, a fitting tube extending outward into the body from a peripheral side of the circular orifice, and inner threads formed in the circular orifice and the fitting tube as one piece; and
an outlet pipe including a connecting segment, an outlet segment, and a rotary connector fitted and limited in the connecting segment, the rotary connector having an outer threaded tube partially extending out of the connecting segment of the outlet pipe to screw with the inner threads formed in the circular orifice and the fitting tube, thus securely connecting the outlet pipe and the body together.

2. The connecting structure for the outlet pipe of the faucet as claimed in claim 1, wherein the fitting tube of the body horizontally extends outward into the body from the peripheral side of the circular orifice, such that the outlet pipe horizontally connects with the body.

3. The connecting structure for the outlet pipe of the faucet as claimed in claim 1, wherein the fitting tube of the body obliquely extends outward into the body from the peripheral side of the circular orifice and obliquely cooperates with the connecting segment of the outlet pipe, such that the outlet pipe connects with the body at a tilted angle.

4. The connecting structure for the outlet pipe of the faucet as claimed in claim 1, wherein the rotary connector has a head portion arranged on a first end thereof and retained in the connecting segment of the outlet pipe, a stop ring fitted on a peripheral side of the head portion and contacting with an inner wall of the outlet pipe, an outer threaded tube arranged on a second end thereof.

5. The connecting structure for the outlet pipe of the faucet as claimed in claim 1, wherein the outlet pipe further includes a groove defined on an end surface of the connecting segment and fitted with a closing ring, and the closing ring contacts with an outer wall of the body to stop water leakage.

6. The connecting structure for the outlet pipe of the faucet as claimed in claim 1, wherein the rotary connector further has a through orifice axially passing therethrough.
